(19) United States
(12) Patent Application Publication
(10) Pub. No.: US 2004/0170886 A1
(43) Pub. Date: Sep. 2, 2004

(54) Fuel cell and material of gas diffusion layer

(75) Inventor: Shigeru Sakamoto, Ota-shi (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/724,606

(22) Filed: Dec. 2, 2003

(30) Foreign Application Priority Data
Dec. 2, 2002 (JP) JP2002-350245
Nov. 20, 2003 (JP) JP2003-391482

(51) Int. Cl. H01M 4/94; H01M 4/96

(52) U.S. Cl. 429/44; 429/42

(57) ABSTRACT

A fuel cell including a gas diffusion layer having excellent water retention capability is to be provided.

The gas diffusion layer is constituted of a modified cross-sectioned carbon fiber. Examples of a modified cross-section include a cross-shape, an X-shape, a Y-shape, a W-shape, an H-shape, an L-Shape, a star-shape, a multifoil-shape and so forth. Employing a modified cross-sectioned carbon fiber for constituting the gas diffusion layer permits moisture to be retained in a recess located between protruding portions, thereby upgrading water retention capability of the gas diffusion layer.

### BACKGROUND OF THE INVENTION

1. Field of the Invention

The present invention relates to a fuel cell, more specifically to a fuel cell provided with a gas diffusion layer.

2. Description of the Related Art

Recently fuel cells have been attracting attention because they offer high energy conversion efficiency without producing a hazardous substance through power generating reaction. A polymer electrolyte fuel cell that operates in a temperature as low as below 100 degree centigrade is known as one of such fuel cells.

A polymer electrolyte fuel cell is basically constituted of a fuel electrode and an air electrode with a solid polymer membrane disposed therebetween for serving as an electrolyte membrane, and is designed to generate electricity according to the following chemical reaction formula upon supplying hydrogen to the fuel electrode and oxygen to the air electrode.

Fuel electrode: H₂→2H⁺+2e⁻ (1)

Air electrode:½O₂+2H⁺+2e⁻→H₂O (2)

The fuel electrode and the air electrode respectively consist of a catalyst layer and a gas diffusion layer laid over each other. These electrodes are placed in such a manner that the catalyst layers of the respective electrodes confront each other via the solid polymer membrane, thus to constitute a fuel cell. The catalyst layer consists of carbon particles carrying a catalyst bound by an ion exchanging resin. The gas diffusion layer serves as a channel for oxygen and hydrogen. Power generating reaction takes place at so-called a three-phase interface of the catalyst in the catalyst layer, the ion exchanging resin and a reactant which is hydrogen or oxygen.

In the fuel electrode, hydrogen contained in supplied fuel gas is decomposed into a hydrogen ion and an electron as shown in the formula (1). The hydrogen ion moves toward the air electrode through inside the solid polymer electrolyte membrane, while the electron moves to the air electrode through an external circuit. In turn, on the side of the air electrode, oxygen contained in the supplied air reacts with the hydrogen ion and the electron that have moved from the fuel electrode, to give water as shown in the formula (2). Accordingly, electricity can be taken out of the external circuit where the electron moves from the fuel electrode toward the air electrode.

In such polymer electrolyte fuel cell, a function of the gas diffusion layer is to provide the supplied hydrogen gas or air to the catalyst layer. However, when a water film is produced within the gas diffusion layer owing to excessive soaking, gas permeability is lowered and resultantly the electricity generating characteristics of the fuel cell is degraded. Accordingly, in order to restrain the degradation of gas permeability, techniques of employing a porous substrate such as a carbon paper or giving water-repellency to the gas diffusion layer with a fluororesin have been disclosed (Refer to JPA laid open Hei10-289723 for example).

Related Art List

JPA laid open Hei10-289723

Meanwhile, the gas diffusion layer has not only to achieve a certain level of gas permeability, but also to provide the electrolyte membrane with moisture for dampening contained in a form of vapor or liquid in the fuel gas or air, and further to discharge surplus moisture or generated reaction water toward outside. On the other hand, since the electrolyte membrane and catalyst layer have to remain wet to a certain extent, the gas diffusion layer, which is located on an outer side thereof, is required to have water retention capability for retaining moisture inside.

The present invention has been conceived in view of such situation, with an object to provide a gas diffusion layer having excellent capability of water retention and transference, and a fuel cell provided with such gas diffusion layer.

### SUMMARY OF THE INVENTION

According to an aspect of the present invention there is provided a fuel cell comprising an electrolyte membrane; and a first electrode and a second electrode provided on the electrolyte membrane; wherein at least one of the first electrode and the second electrode is provided with a gas diffusion layer including a modified cross-sectioned carbon fiber. With the fuel cell of this aspect, water retention capability is improved because the modified cross-sectional carbon fiber can effectively retain moisture on a surface of the carbon fiber. It is preferable, therefore, that a cross-sectional shape of the modified cross-sectioned carbon fiber has a recess for adsorbing moisture. With such recess, the gas diffusion layer attains upgraded water retention capability.

In order to maintain the moisture retention capability, it is preferable that a degree of irregularity of the modified cross-sectioned carbon fiber is not less than 1.3. Also, from another viewpoint it is preferable that a ratio of a longest distance R against a shortest distance r (R/r) from the center of gravity of a cross-section of the modified cross-sectioned carbon fiber to its outer circumference is not less than 1.2. The cross-section of the modified cross-sectioned carbon fiber may be cross-shaped, X-shaped, Y-shaped, W-shaped, H-shaped, L-Shaped, star-shaped or multifoil-shaped.

Also, the gas diffusion layer may be constituted of a mixture of the modified cross-sectioned carbon fiber and a circular cross-sectioned carbon fiber. For example, the gas diffusion layer may be formed in a woven cloth structure constituted of a weaving yarn solely including the modified cross-sectioned carbon fiber or including the modified cross-sectioned carbon fiber and a circular cross-sectioned carbon fiber in a predetermined proportion, or formed in a nonwoven cloth or paper structure constituted solely of the modified cross-sectioned carbon fiber or of a mixture in a predetermined proportion of the modified cross-sectioned carbon fiber and a circular cross-sectioned carbon fiber.

The gas diffusion layer may be processed with a fluororesin to attain water-repellency in order to improve gas permeability. In order to attain water-repellency a fluororesin may be coated on a surface or an interior portion of the gas diffusion layer, otherwise fluororesin particles may be applied to a surface or filled in an interior portion of the gas diffusion layer. Further, in order to improve water transference capability carbon particles may be applied to a surface or filled in an interior portion of the gas diffusion layer.

A manufacturing method of the foregoing fuel cell, a fuel cell base body that serves as a gas diffusion layer, and a manufacturing method thereof, are all effectively included in the present invention.

### BRIEF DESCRIPTION OF THE DRAWINGS

FIG. 1 is a conceptual cross-sectional view showing a fuel cell according to the embodiment of the present invention;

FIG. 2A shows a cross-shaped cross-section; FIG. 2B shows an X-shaped cross-section; FIG. 2C shows a Y-shaped cross-section; FIG. 2D shows a W-shaped cross-section; FIG. 2E shows an H-shaped cross-section; FIG. 2F shows an L-shaped cross-section; FIG. 2G shows a star-shaped cross-section; FIG. 2H shows a multifoil-shaped cross-section;

FIG. 3 is an explanatory illustration for explaining a multifoil-shaped cross-section; and

FIG. 4 is an explanatory illustration for explaining a distance ratio from the center of gravity in a multifoil-shaped cross-section.

### DESCRIPTION OF THE PREFERRED EMBODIMENT

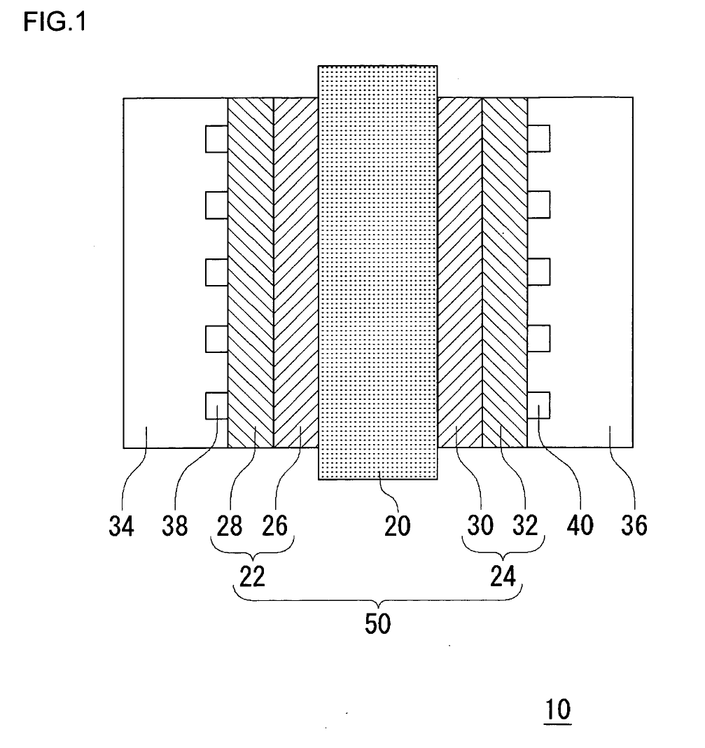

FIG. 1 is a conceptual cross-sectional view showing a fuel cell 10 according to the embodiment of the present invention. The fuel cell 10 is provided with a plate-formed cell unit 50, on both sides of which a separator 34 and another separator 36 are placed. This embodiment shows a single cell unit 50, however a plurality of cell units 50 may be layered via the separator 34 or 36 to constitute the fuel cell 10. The cell unit 50 includes a solid polymer electrolyte membrane 20, a fuel electrode 22 and an air electrode 24. The fuel electrode 22 and the air electrode 24 may be called a “catalyst electrode”. The fuel electrode 22 includes a catalyst layer 26 and a gas diffusion layer 28 layered over each other, and the air electrode also includes a catalyst layer 30 and a gas diffusion layer 32 layered over each other. The catalyst layer 26 of the fuel electrode and the catalyst layer 30 of the air electrode 24 are disposed so as to face each other via the solid polymer electrolyte membrane 20.

The separator 34 placed on the side of the fuel electrode 22 is provided with a gas channel 38, through which a fuel gas is supplied to the cell unit 50. Likewise, the separator 36 placed on the side of the air electrode 24 is also provided with a gas channel 40, through which an oxidant gas is supplied to the cell unit 50. Specifically, during operation of the fuel cell 10 a fuel gas such as hydrogen gas is supplied to the fuel electrode 22 through the gas channel 38, and an oxidant gas, for example air, is supplied to the air electrode 24 through the gas channel 40. This situation causes electricity generating reaction in the cell unit 50. When hydrogen gas is supplied to the catalyst layer 26 through the gas diffusion layer 28 the hydrogen in the gas turns into proton, i.e. hydrogen ion, and the proton moves toward the air electrode 24 through the solid polymer electrolyte membrane 20. Electron emitted at this stage moves to an external circuit and flows into the air electrode through the external circuit. Meanwhile, when air is supplied to the catalyst layer 30 through the gas diffusion layer 32, the oxygen contained in the air joins with the proton to become water. As a result, the electron runs from the fuel electrode 22 to the air electrode 24 through the external circuit, therefore electricity can be taken out of the external circuit.

The solid polymer electrolyte membrane 20 offers high ion conductivity in a wet condition, because of its function as an ion exchanging membrane for moving the proton between the fuel electrode 22 and the air electrode 24. The solid polymer electrolyte membrane 20 may be constituted of a solid polymer material such as a fluorine-based polymer or a non-fluorine polymer. Examples of the fluorine-based polymer include a sulfonic acid type perfluorocarbon polymer, a polysulfonic resin, a perfluorocarbon polymer containing a phosphonic acid group or a carboxylic acid group, etc. As an example of the sulfonic acid type perfluorocarbon polymer, Nafion (manufactured by E.I. du Pont de Nemours and Company, registered trademark) 112 can be cited. Also, examples of the non-fluorine polymer include a sulfonated aromatic polyetherketone, sulfonated polyethersulfone, etc.

The gas diffusion layer 28 in the fuel electrode 22 and the gas diffusion layer 32 in the air electrode 24 serve to convey the supplied hydrogen gas or air to the catalyst layer 26 or the catalyst layer 30. Also, these gas diffusion layers have the functions to transfer the electric load generated by the electricity generating reaction to an external circuit and to discharge moisture or surplus gas outside. It is preferable that the gas diffusion layer 28 and the gas diffusion layer 32 are constituted of an electronically conductive porous base body, such as a carbon paper, a carbon cloth, or a carbon nonwoven cloth.

The catalyst layer 26 in the fuel electrode 22 and the catalyst layer 30 in the air electrode 24 are porous membranes, preferably constituted of at least an ion exchanging resin and carbon particles carrying a catalyst. Examples of the catalyst to be carried include a rare metal such as platinum, gold, silver, rhodium, ruthenium, or an alloy containing these metals. Also, acetylene black, Ketjenblack, furnace black, carbon nanotube, etc. may be used as the carbon particle to carry a catalyst.

The ion exchanging resin serves as a proton conducting path between a catalyst carried by a carbon particle and the solid polymer electrolyte membrane 20. Accordingly, an ion exchanging resin has to have proton conductivity, and also a certain level of gas permeability for diffusing hydrogen or oxygen toward a catalyst. The ion exchanging resin may be formed of a similar polymer material to that of the solid polymer electrolyte membrane 20.

Hereunder, a method of manufacturing the cell unit 50 will be described. Firstly, a carbon particle is caused to carry a catalytic such as platinum by impregnation or colloid method, to form the fuel electrode 22 and the air electrode 24. Then the catalyst-carrying carbon particle and an ion exchanging resin are dispersed in a solvent, so that a catalytic ink is made. Thereafter, the catalytic ink is coated on for example a carbon paper, which is to serve as the gas diffusion layer, and heated and dried so that the fuel electrode 22 and the air electrode 24 are obtained. The application of the catalytic ink may be performed for example by brush coating, spraying, screen printing, doctor blade coating, transfer printing. Then the solid polymer electrolyte membrane 20 is interleaved between the fuel electrode 22 and the air electrode 24, such that the respective catalyst layers 26 and 30 confront the solid polymer electrolyte membrane 20, and bonded by hot press method. Thus the cell unit 50 is completed. In case where the solid polymer electrolyte membrane 20 and the ion exchanging resin for the catalyst layers 26, 30 are constituted of a polymer that has a softening point or causes a glass transition, it is preferable to execute the hot press at a temperature higher than the softening point or the glass transition temperature.

Another manufacturing method of the cell unit 50 will be described below. The catalyst layers 26, 30 may be formed by directly applying a catalyst ink to the solid polymer electrolyte membrane 20, followed by heating and drying, in which case the catalyst ink may be coated by spraying. Then the gas diffusion layers 28, 32 can be formed over the catalyst layers 26, 30 respectively by a hot press method, thus to complete the cell unit 50. Still another manufacturing method of the cell unit 50 is to first form the catalyst layers 26, 30 by applying a catalyst ink for example to a Teflon sheet with subsequent heating and drying, in which case the catalyst ink may be coated by spraying or screen printing. Then the catalyst layers 26, 30 respectively formed on the Teflon sheets are disposed face to face with the solid polymer electrolyte membrane 20 therebetween and joined by a hot press method. Thereafter the gas diffusion layers 28, 32 can be formed over the catalyst layers 26, 30 respectively, upon removing the Teflon sheets.

In this embodiment, at least one of the fuel electrode 22 and the air electrode 24 is provided with the gas diffusion layer 28 or 32 including a modified cross-sectioned carbon fiber. Hereinafter, for the sake of simplicity in explaining, the gas diffusion layer 32 in the air electrode 24 will be designated to include a modified cross-sectioned carbon fiber. The gas diffusion layer 32 is expected to discharge water toward outside when there is excessive moisture, but to retain water inside when moisture is not sufficient.

A “modified cross-sectioned carbon fiber” stands for a carbon fiber formed in a special cross-sectional shape, such as a cross-shape, an X-shape, a Y-shape, a W-shape, an H-shape, an L-Shape, a star-shape, etc. It is preferable that such carbon fiber has a thickness of 2 to 20 μm, more preferably 5 to 12 μm, especially approx. 8 μm, from the viewpoint of strength and thickness controllability. In this embodiment, the term of “modified cross-section” defines a distinction from a circular or a substantially circular cross-section. The “substantially circular cross-section” includes a cross-section that can be described as circular as a whole despite having a slight unevenness, such as those not intended to form a modified cross-section as a designing concept. By contrast, a carbon fiber having a circular or a substantially circular cross-section will be referred to as a “circular cross-sectioned carbon fiber”.

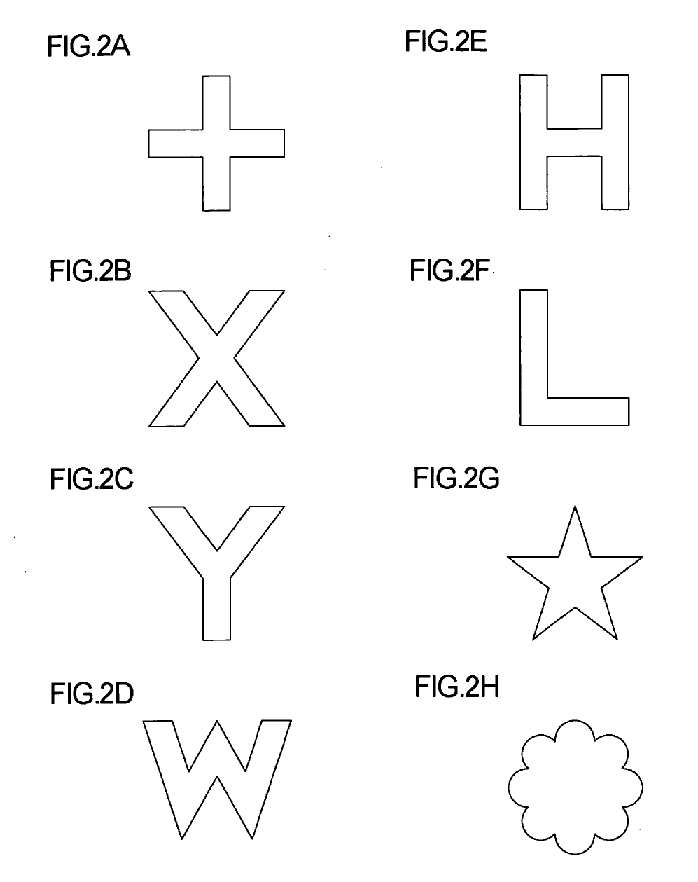

FIGS. 2A to 2H respectively show a cross-sectional shape of a modified cross-sectioned carbon fiber. Specifically, FIG. 2A shows a cross-shaped cross-section; 2B shows an X-shaped cross-section; 2C shows a Y-shaped cross-section; 2D shows a W-shaped cross-section; 2E shows an H-shaped cross-section; 2F shows an L-shaped cross-section; 2G shows a star-shaped cross-section; and 2H shows a multifoil-shaped cross-section. Also, a cross-sectional shape of the modified cross-sectioned carbon fiber is not limited to those shown in FIGS. 2A to 2H, but can be a different shape.

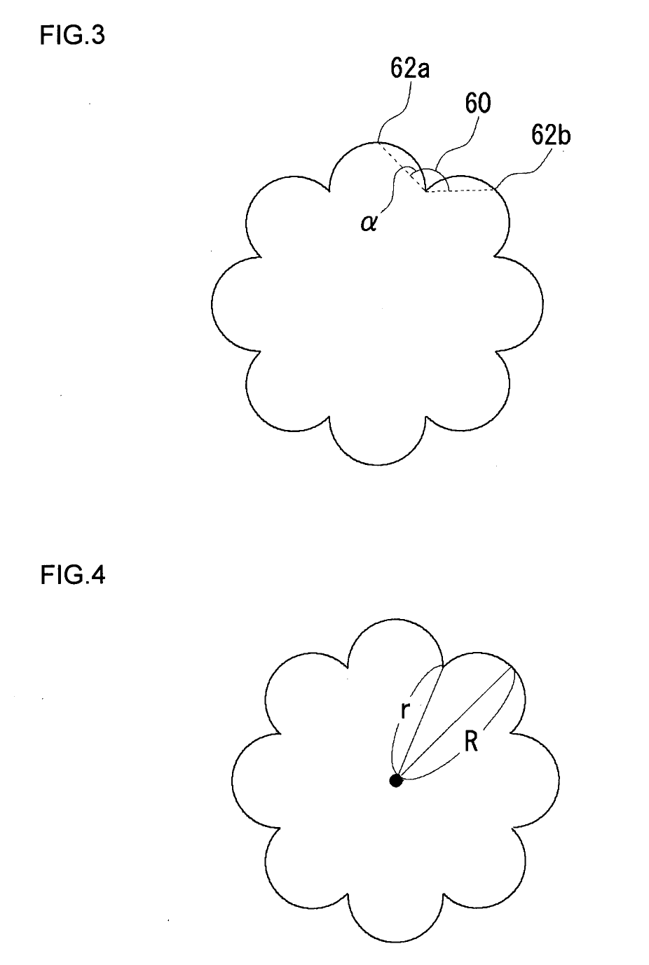

FIG. 3 is an explanatory illustration for explaining a multifoil-shaped cross-section shown in FIG. 2H. This multifoil-shaped cross-section includes two protruding portions 62a, 62b and a recess 60. As illustrated, this example includes a plurality of recesses. The recess 60 is a region defined by the adjacent protruding portions 62a, 62b. More specifically, upon drawing a tangent line that connects the protruding portion 62a and the protruding portion 62b, a region inside the tangent line, i.e. on the side of the fiber is the recess 60. From another viewpoint, referring to the shape of FIG. 2H, an angle α defined by segments drawn from the lowest point of the recess 60 to the respective highest points of the protruding portions 62a, 62b is narrower than 180 degrees. A definition of the lowest point and the highest point may be determined depending on a cross-sectional shape as the case may be, while in this case the lowest point of the recess 60 is defined as the nearest point in the recess 60 from the center of gravity of the cross-section, and the highest points as the respective farthest points in the protruding portions 62a, 62b from the center of gravity of the cross section. In addition, the angle α corresponds to an angle of the recess 60 viewed from outside. A region that corresponds to one of the above definitions will be referred to as the recess 60.

Forming the recess 60 on the carbon fiber makes it easier for water to be retained therein. Accordingly the recess 60 serves to retain moisture, thereby upgrading water retention capability of the gas diffusion layer 32. Also, it is apparent to those skilled in the art that a different modified cross-sectional shape from the multifoil-shape of FIG. 2H is also provided with a recess, in view of FIGS. 2A to 2G. For example, a cross-shaped cross-section as FIG. 2A has a right angled recess formed at an intersection of the cross.

The gas diffusion layer 32 may be given water-repellency by fluororesin processing. With the water-repellent function, deposition of water in the gas diffusion layer 32 is prevented so that a gas can be smoothly supplied through the water-repellent region. Also, carbon particles may be coated on a surface or filled in an interior portion of the gas diffusion layer 32. As a result, a capillary water path constituted of hydrophilic carbon particles is formed. When discharging reacted water produced in the catalyst layer 30 the capillary path can be utilized to guide the water. Since the reacted water produced in the catalyst layer is discharged outside through the gas diffusion layer 32, it is useful to dispose carbon particles in the proximity of an interface of the catalyst layer 30 and the gas diffusion layer 32, from the viewpoint of improving water transference capability. Further, since the recess 60 is formed on the cross-section of the carbon fiber, the recess 60 can serve also as a water path, thereby further upgrading the water transference capability of the gas diffusion layer 32.

The gas diffusion layer 32 may be constituted solely of a modified cross-sectioned carbon fiber, or of a mixture of the modified cross-sectioned carbon fiber and a circular cross-sectioned carbon fiber. Specifically, the gas diffusion layer 32 may be formed in a woven cloth structure constituted solely of a modified cross-sectioned carbon fiber or of a weaving yarn in which the modified cross-sectioned carbon fiber and a circular cross-sectioned carbon fiber are mixed in a predetermined proportion, or formed in a nonwoven cloth or paper structure constituted solely of the modified cross-sectioned carbon fiber or of a mixture in a predetermined proportion of the modified cross-sectioned carbon fiber and a circular cross-sectioned carbon fiber. The weaving yarn may be constituted of a spun yarn or a blended yarn made of a staple fiber, or a multi-filament yarn or a combined filament yarn made of a filament fiber.

Now an evaluation index of the modified cross-section referred to in this embodiment will be described hereunder. As an index for evaluating a modified cross-section, it is preferable to adopt a concept of “degree of irregularity” of a cross-section. The degree of irregularity of a cross-section is calculated by the following formula.

Degree of irregularity=L/L₀=L/(4·π·S)^{1/2}

Wherein L is a circumferential length of the cross-section of a modified cross-sectioned carbon fiber, L₀ is a circumferential length of a circle that has the same cross-sectional area as that of the modified cross-sectioned carbon fiber, and S is a cross-sectional area of the modified cross-sectioned carbon fiber.

The modified cross-sectioned carbon fiber described in this embodiment is provided with a recess for adsorbing water therein, and its preferable degree of irregularity is not less than 1.3, more preferably not less than 1.5, and desirably 2 or greater. When the degree of irregularity of 1.3 or greater is attained, a carbon fiber provided with a recess capable of adsorbing water can be obtained. With the degree of irregularity of 1.5 or greater, water retention capability of the recess can also be improved, and with the degree of irregularity of 2 or greater, water transference capability of the recess, in addition to water retention capability, can also be improved.

Also, a distance ratio from the center of gravity in a cross-section can also be utilized as another evaluation index of a modified cross-section. FIG. 4 is an explanatory illustration for explaining a distance ratio from the center of gravity in a multifoil-shaped cross-section. When the longest distance from the center of gravity to an outer circumference in a modified cross-sectioned carbon fiber is designated by R and the shortest distance by r, a ratio of the longest distance R with respect to the shortest distance r is calculated by the following formula.

Distance ratio=R/r

The modified cross-sectioned carbon fiber described in this embodiment is provided with a recess for adsorbing water therein, and its preferable distance ratio is not less than 1.2, more preferably not less than 1.4, and more desirably 1.8 or greater. When the distance ratio of 1.2 or greater is attained, a carbon fiber provided with a recess capable of adsorbing water can be obtained. With the distance ratio of 1.4 or greater, water retention capability of the recess can also be improved, and with the distance ratio of 1.8 or greater, water transference capability of the recess, in addition to water retention capability, can also be improved.

Hereunder, a manufacturing method of fuel cell base body that serves as a gas diffusion layer, specifically a carbon nonwoven cloth in this case, will be described. First an acrylonitrile polymer is dissolved in a solvent so that a yarn spinning solution is produced. The solvent may be either organic or inorganic. For spinning a yarn either wet spinning or dry spinning process may be employed, while it is preferable to employ the wet spinning process because control of a cross-sectional shape of the yarn is easier.

In case of employing the wet spinning process, the spinning solution is injected through a spinning nozzle into a coagulation bath, so that a coagulated yarn is formed. In this embodiment the spinning nozzle is provided for defining a modified cross-sectional shape of the yarn, therefore in case where the yarn is to have, for example, a multifoil-shaped cross-section, the spinning nozzle may be provided with a plurality of openings of a predetermined shape aligned along its circumferential portion. Also, an additional opening may be provided at a center of the circle. The spinning solution is injected through such openings, and the plurality of filaments of the injected spinning solution are joined and bonded before the spinning solution solidifies or coagulates, so that a coagulated fiber is obtained. Further, it is also preferable to provide the spinning nozzle with an opening of a determined shape according to a desired modified cross-sectional shape, and to inject the spinning solution through the opening to produce the coagulated yarn. In this case the coagulated yarn is wound on a reel for subsequent process of drawing, cleaning and drying for producing the desired modified cross-sectioned fiber.

The modified cross-sectioned fiber obtained through the foregoing process is then fabricated into a nonwoven cloth, and finally a carbon nonwoven cloth is produced through flameproof treatment and carbonization process. In addition, the modified cross-sectioned fiber may be dipped in a fluororesin solution to form a fluororesin coating so that water-repellency is attained. It is also preferable to apply a mixed paste of a carbon powder and a fluororesin, to obtain water transference capability. The carbon powder to be employed may be a powder of a carbon black, an acetylene black or an artificial graphite. The carbon nonwoven cloth may be fabricated exclusively from a modified cross-sectioned fiber or from a mixture in a predetermined proportion of the modified cross-sectioned fiber and a circular cross-sectioned fiber.

The present invention has been described as above referring to the embodiment. It is to be understood that this embodiment is only exemplifying and that it is apparent to those skilled in the art that various modifications can be made to the respective constituents or processing steps or combinations thereof, without departing from the spirit and scope of the present invention. In the embodiment, the air electrode 24 is provided with the gas diffusion layer 32 including the modified cross-sectioned carbon fiber. Similarly, the fuel electrode 22 may be provided with the gas diffusion layer 28 including the modified cross-sectioned carbon fiber.

The cell unit 50, explained above, may generate electricity in a temperature over 100 degree centigrade or use an electrolyte membrane in which a high level of wetness is not required. In a case that the present invention is applied to a fuel cell which can operate in such a condition, that is, over 100 degree centigrade or with a low level of wetness, it is expected that a stable operation can be realized because a surface area of the modified cross-sectioned carbon fiber is larger than that of the circular cross-sectioned carbon fiber so that its capability for retaining and discharging moisture is better.

Some types of polymer electrolyte fuel cells use a liquid fuel. A direct methanol fuel cell (DMFC) is a typical one, in which a methanol solvent is directly supplied to a fuel electrode. On the side of the fuel electrode, methanol reacts with water to generate carbon dioxide, hydrogen ion and electron, on the side of the air electrode, oxygen reacts with hydrogen ion and electron to generate water.

Herein, the fuel electrode should supply a liquid methanol solvent to the catalyst layer through the gas diffusion layer, and diffuse carbon dioxide to outside promptly through the gas diffusion layer which is generated by electrode-reaction of the catalyst layer. That is, capabilities of water retention, water transference and gas diffusion are required to the gas diffusion layer of the fuel electrode of DMFC. Therefore, the present invention can be applied to the fuel cell like DMFC that uses liquid fuel.

What is claimed is:

1. A fuel cell comprising:
an electrolyte membrane; and
a first electrode and a second electrode provided on said electrolyte membrane;
wherein at least one of said first electrode and said second electrode is provided with a gas diffusion layer including a modified cross-sectioned carbon fiber.

2. The fuel cell as set forth in claim 1, wherein said modified cross-sectioned carbon fiber has a recess in a cross-sectional shape thereof.

3. The fuel cell as set forth in claim 2, wherein said recess provides said gas diffusion layer with water retention capability.

4. The fuel cell as set forth in claim 1, wherein a degree of irregularity of said modified cross-sectioned carbon fiber is not less than 1.3.

5. The fuel cell as set forth in claim 2, wherein a degree of irregularity of said modified cross-sectioned carbon fiber is not less than 1.3.

6. The fuel cell as set forth in claim 3, wherein a degree of irregularity of said modified cross-sectioned carbon fiber is not less than 1.3.

7. The fuel cell as set forth in claim 1, wherein a ratio of a longest distance R against a shortest distance r (R/r) from the center of gravity of a cross-section of said modified cross-sectioned carbon fiber to an outer circumference thereof is not less than 1.2.

8. The fuel cell as set forth in claim 2, wherein a ratio of a longest distance R against a shortest distance r (R/r) from the center of gravity of a cross-section of said modified cross-sectioned carbon fiber to an outer circumference thereof is not less than 1.2.

9. The fuel cell as set forth in claim 3, wherein a ratio of a longest distance R against a shortest distance r (R/r) from the center of gravity of a cross-section of said modified cross-sectioned carbon fiber to an outer circumference thereof is not less than 1.2.

10. The fuel cell as set forth in claim 1, wherein a cross-section of said modified cross-sectioned carbon fiber is one of a cross-shape, an X-shape, a Y-shape, a W-shape, an H-shape, an L-Shape, a star-shape and a multifoil-shape.

11. The fuel cell as set forth in claim 1, wherein said gas diffusion layer is constituted essentially of a mixture of said modified cross-sectioned carbon fiber and a circular cross-sectioned carbon fiber.

12. The fuel cell as set forth in claim 2, wherein said gas diffusion layer is constituted essentially of a mixture of said modified cross-sectioned carbon fiber and a circular cross-sectioned carbon fiber.

13. The fuel cell as set forth in claim 3, wherein said gas diffusion layer is constituted essentially of a mixture of said modified cross-sectioned carbon fiber and a circular cross-sectioned carbon fiber.

14. The fuel cell as set forth in claim 1, wherein said gas diffusion layer is formed in a woven cloth structure constituted essentially of a weaving yarn solely including said modified cross-sectioned carbon fiber or including said modified cross-sectioned carbon fiber and a circular cross-sectioned carbon fiber in a predetermined proportion.

15. The fuel cell as set forth in claim 2, wherein said gas diffusion layer is formed in a woven cloth structure constituted essentially of a weaving yarn solely including said modified cross-sectioned carbon fiber or including said modified cross-sectioned carbon fiber and a circular cross-sectioned carbon fiber in a predetermined proportion.

16. The fuel cell as set forth in claim 3, wherein said gas diffusion layer is formed in a woven cloth structure constituted essentially of a weaving yarn solely including said modified cross-sectioned carbon fiber or including said modified cross-sectioned carbon fiber and a circular cross-sectioned carbon fiber in a predetermined proportion.

17. The fuel cell as set forth in claim 1, wherein said gas diffusion layer is formed in a nonwoven cloth or paper structure constituted substantially of said modified cross-sectioned carbon fiber alone or of a mixture in a predetermined proportion of said modified cross-sectioned carbon fiber and a circular cross-sectioned carbon fiber.

18. The fuel cell as set forth in claim 2, wherein said gas diffusion layer is formed in a nonwoven cloth or paper structure constituted substantially of said modified cross-sectioned carbon fiber alone or of a mixture in a predetermined proportion of said modified cross-sectioned carbon fiber and a circular cross-sectioned carbon fiber.

19. The fuel cell as set forth in claim 3, wherein said gas diffusion layer is formed in a nonwoven cloth or paper structure constituted substantially of said modified cross-sectioned carbon fiber alone or of a mixture in a predetermined proportion of said modified cross-sectioned carbon fiber and a circular cross-sectioned carbon fiber.

20. The fuel cell as set forth in claim 1, wherein said gas diffusion layer is processed with a fluororesin to attain water-repellency.

21. The fuel cell as set forth in claim 1, wherein carbon particles are applied to a surface or filled in an interior portion of said gas diffusion layer.

22. The fuel cell as set forth in claim 4, wherein carbon particles are applied to a surface or filled in an interior portion of said gas diffusion layer.

23. The fuel cell as set forth in claim 7, wherein carbon particles are applied to a surface or filled in an interior portion of said gas diffusion layer.

24. The fuel cell as set forth in claim 11, wherein carbon particles are applied to a surface or filled in an interior portion of said gas diffusion layer.

25. The fuel cell as set forth in claim 1, wherein said fuel cell generates electricity in a temperature over 100 degree centigrade.

26. The fuel cell as set forth in claim 1, wherein said fuel cell can operate under low-wet condition.

27. A material of a gas diffusion layer of a fuel cell including a modified cross-sectioned carbon fiber.
